(19) United States
(12) Patent Application Publication
(10) Pub. No.: US 2010/0216889 A1
(43) Pub. Date: Aug. 26, 2010

(54) PROLONGED EFFECT DISINFECTANT CLEANSER

(75) Inventors: Shanta M. Modak, River Edge, NJ (US); Ingrid Geraldo, New York, NY (US); Lauserpina Caraos, Hollis, NY (US); Nayana Baiju, New York, NY (US)

Correspondence Address: BAKER BOTTS L.L.P., 30 ROCKEFELLER PLAZA, 44TH FLOOR, NEW YORK, NY, 10112-4498, US

(73) Assignee: THE TRUSTEES OF COLUMBIA UNIVERSITY IN THE CITY OF, NEW YORK, NY (US)

(21) Appl. No.: 12/663,231

(22) PCT Filed: Jun. 6, 2008
(86) PCT No.: PCT/US08/66142

§ 371 Date: May 11, 2010

Related U.S. Application Data
(60) Provisional application No. 60/942,610, filed on Jun. 7, 2007.

(51) Int. Cl. A01N 37/52; A01N 33/12; A01N 31/14; A01P 1/00

(52) U.S. Cl. 514/635; 514/642; 514/717

(57) ABSTRACT

The present invention relates to cleanser compositions, and their uses, wherein the cleanser compositions comprise one or more cationic antiseptic agents, a film-forming cationic emulsifying agent, a dispersing auxiliary solvent, a solvent system, and optionally an alkanediol.

### PRIORITY INFORMATION

This application claims priority to U.S. Provisional Application Ser. No. 60/942,610, filed Jun. 7, 2007, which is incorporated by reference in its entirety herein.

### GRANT INFORMATION

Not applicable.

### 1. INTRODUCTION

The present invention provides for cleansers, and use thereof, which provide enhanced and persistent antimicrobial activity.

### 2. BACKGROUND OF THE INVENTION

“Skin disinfectants (or cleansers)” are routinely used in professional and non-professional contexts to rapidly kill microbes. A physician has a need to disinfect his or her skin both before and after examining a patient. Prior to the performance of an invasive medical procedure, the skin of the subject must be properly cleaned to avoid post-procedure infections. In the general public, there is an awareness that the spread of infectious diseases can occur by first coming in physical contact with a source of infection—for example touching a contaminated object, and then touching one's eye. To address these needs, a number of different topical disinfectants have been made available.

For example, a number of skin disinfectants have been developed that use alcohol as the primary antimicrobial agent. Alcohol-based skin disinfectants which are known in the art include the following.

International Patent Application Publ. No. WO 03/034994 by Modak et al. for “Gentle-Acting Skin Disinfectants and Hydroalcoholic Gel Formulations” discloses compositions comprising antimicrobial agents and octoxyglycerin.

U.S. Pat. No. 6,107,261 by Taylor et al., issued Aug. 22, 2000, and its continuations-in-part, U.S. Pat. No. 6,204,230 by Taylor et al., issued Mar. 20, 2001 and U.S. Pat. No. 6,136,771 by Taylor et al., issued Oct. 24, 2000, disclose antibacterial compositions which contain an antibacterial agent at a percent saturation of at least 50 percent. The compositions further comprise, as solubility promoters, a surfactant and a hydric solvent, which may be an alcohol.

U.S. Pat. No. 5,776,430 by Osborne et al., issued Jul. 7, 1998, discloses a topical antimicrobial cleaner containing about 0.65-0.85 percent chlorhexidine and about 50-60 percent denatured alcohol, which is scrubbed onto and then rinsed off the skin.

European Patent Application 0604 848 discloses a gel comprising an antimicrobial agent, 40-90 percent by weight of an alcohol, and a polymer and thickening agent.

U.S. Pat. No. 4,956,170 by Lee, issued Sep. 11, 1990 relates to a high alcohol content antimicrobial gel composition which comprises various emollients and a humectant to protect the skin from the drying effects of the alcohol. In alcohol formulations, higher levels of alcohol are needed to provide instant kill against sensitive as well as resistant strains of bacteria.

Certain formulations virtually omit alcohol as a primary antimicrobial agent, such as, for example, the skin sanitizing compositions disclosed in U.S. Pat. No. 6,187,327 by Stack, issued Feb. 13, 2001, which comprises triclosan (2,4,4′-trichloro-2′-hydroxydiphenyl ether; concentration 0.1-0.35 weight percent) in a topical lotion comprised of a surfactant phase and a wax phase, which purportedly provides antimicrobial protection for 3-4 hours after application. The composition prepared according to the claims of U.S. Pat. No. 6,187,327 further comprises chlorhexidine digluconate.

Examples of other disclosures relating to skin disinfectants include the following.

U.S. Pat. No. 6,846,846 by Modak et al. relates to “Gentle-Acting Skin Disinfectants” which comprise octoxyglycerine and an additional antimicrobial agent.

United States Patent Application Publication No. 20050048139 by Modak et al. relates to “Zinc Salt Compositions For The Prevention of Dermal And Mucosal Irritation.”

United States Patent Application Publication No. 20050019431 by Modak et al. relates to “Antimicrobial Compositions Containing Synergistic Combinations Of Quaternary Ammonium Compounds And Essential Oils And/Or Constituents Thereof.”

U.S. Pat. No. 5,965,610 by Modak et al., issued Oct. 12, 1999, teaches skin cleaning compositions comprising antimicrobial agents and zinc salts, where zinc salts have a soothing effect on the skin. The claimed subject matter includes formulations comprising a gel formed between zinc gluconate, chlorhexidine gluconate and a solvent, to which various thickening agents, emulsifying agents and/or emollients may be added.

U.S. Pat. No. 5,985,918 by Modak et al., issued Nov. 16, 1999, relates to “Zinc-Based Anti-Irritant Creams”.

U.S. Pat. No. 5,705,532 by Modak et al., issued Jan. 6, 1998, relates to “Triple Antimicrobial Compositions” comprising less than or equal to two percent of a chlorhexidine compound, less than or equal to 0.1 percent of a quaternary ammonium compound, and less than or equal to two percent parachlorometaxylenol.

Cleansers with effective antimicrobial activity are desirable for use in the home, in schools, during travel, and in healthcare settings (to name a few). However, even where a surface is successfully cleaned, exposure to new microbes can quickly negate the benefits of cleansing. A cleanser having persistent residual antimicrobial activity would address this issue and help in preventing the spread of infectious agents.

### 3. SUMMARY OF THE INVENTION

The present invention relates to cleanser compositions, and their uses, wherein the cleanser compositions comprise one or more cationic antiseptic agents, a film-forming cationic emulsifying agent, a dispersing auxiliary solvent, a solvent system, and optionally an alkanediol. It is based, at least in part, on the discovery that cleanser compositions comprising these components provide residual antimicrobial activity which has, in laboratory testing, proved superior to compositions lacking such formulation.

### 4. DETAILED DESCRIPTION OF THE INVENTION

The present invention relates to cleanser compositions, and their uses, wherein the cleanser compositions comprise one or more cationic antiseptic agents, a film-forming and/or surface-coating cationic emulsifying agent, a dispersing auxiliary solvent, a solvent system, and optionally an alkanediol. Preferred non-limiting embodiments further comprise a non-ionic polymer which serves as a foaming agent. For clarity, and not by way of limitation, the detailed description is divided into the following subsections:

(i) cationic antiseptic agents;

(ii) cationic emulsifying agents;

(iii) dispersing auxiliary solvents;

(iv) non-ionic polymers;

(v) solvent systems;

(vi) alkanediols;

(vii) cleanser compositions; and

(viii) methods of use.

### 4.1 Cationic Antiseptic Agents

A “cationic antiseptic agent,” as that term is used herein, is a compound having a net positive charge which inhibits the growth of microorganisms. Without being limited by any theory, it is believed that such agents tend to bind or adhere to the surface of the skin.

A first non-limiting example of a cationic antiseptic agent which may be used according to the invention is a biguanide antiseptic, such as, but not limited to, chlorhexidine, as a free base or salt, and polyhexamethylene biguanide. Chlorhexidine salts that may be used according to the invention include but are not limited to the following: chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine di-iodobutyrate, chlorhexidine di-n-valerate, chlorhexidine dicaproate, chlorhexidine malonate, chlorhexidine succinate, chlorhexidine malate, chlorhexidine tartrate, chlorhexidine dimonoglycolate, chlorhexidine mono-diglycolate, chlorhexidine dilactate, chlorhexidine di-.alpha.-hydroxyisobutyrate, chlorhexidine diglucoheptonate, chlorhexidine di-isothionate, chlorhexidine dibenzoate, chlorhexidine dicinnamate, chlorhexidine dimandelate, chlorhexidine di-isophthalate, chlorhexidine di-2-hydroxy-naphthoate, and chlorhexidine embonate. In specific non-limiting embodiments, the amount of biguanide is between about 0.025 and 2.0 percent, or between about 0.2 and 2.0 percent, or between about 0.2 and 1.0 percent, by weight, of the cleanser composition. “About,” as used herein, means plus or minus twenty percent of the recited value(s). Also, unless indicated otherwise, percentages referred to herein refer to percent by weight (w/w).

A second non-limiting example of a cationic antiseptic agent which may be used according to the invention is triclosan. In specific, non-limiting embodiments, the amount of triclosan is between about 0.025 and 2.0 percent, or between about 0.15 and 1.0 percent, by weight, of the cleanser composition.

A third non-limiting example of a cationic antiseptic agent which may be used according to the invention is a quaternary ammonium compound, such as benzethonium chloride or benzalkonium chloride or a combination thereof, in an amount between 0.1 and 0.3 percent by weight of the cleansing composition.

A fourth non-limiting example of a cationic antiseptic agent which may be used according to the invention is a compound of the bispyridine class, such as octenidine dihydrochloride. In specific, non-limiting embodiments of the invention, the amount of octenidine dihydrochloride is between about 0.2 and 2 percent by weight of the cleanser composition.

A fifth non-limiting example of a cationic antiseptic agent which may be used according to the invention is hexetidine. In specific, non-limiting embodiments of the invention, the amount of hexetidine is between about 0.05 and 1.0 percent by weight, or between about 0.1 and 0.3 percent by weight, of the cleanser composition.

### 4.2 Cationic Emulsifying Agents

A “cationic emulsifying agent,” as that term is used herein, is a compound comprising a cationic lipophilic portion and a hydrophilic portion. In preferred embodiments, the compound contains a quaternary ammonium cation and is soluble in the solvent system set forth below. In particular embodiments, the compound is a conditioning and self-emulsifying wax. Desirably, the compound is capable of forming a film or coating when applied to a surface, such as the skin and the cationic moiety of the compound can bind and/or adhere to the skin surface.

Non-limiting examples of cationic emulsifying agents which may be used according to the invention include incroquat compounds such as (but not limited to) behenyltrimonium methosulfate in cetearyl alcohol (e.g., incroquat behenyl TMS and incroquat behenyl TMS 50 (Croda Inc., Edison, N.J.)), behenalkonium chloride and cetyl alcohol (e.g., Incroquat B-65 (Croda Inc., Edison, N.J.)), behenamido propyl ethyl dimonium ethosulfate and stearyl alcohol (Incroquat BES-35 S (Croda Inc., Edison, N.J.)), steralkonium chloride and cetearyl alcohol and PEG-40 Castor oil (e.g., Incroquat CR concentrate (Croda Inc., Edison, N.J.)), Incroquat CTC-30 (Croda Inc., Edison, N.J.), Incroquat DBM-90 (Croda Inc., Edison, N.J.), Incroquat 0-50 (Croda Inc., Edison, N.J.), Incroquat S-DQ-25 (Croda Inc., Edison, N.J.), Incroquat BA-85 (Croda Inc., Edison, N.J.), Incroquat WG-85 (Croda Inc., Edison, N.J.), as well as distearyldimonium chloride (e.g., VARISOFT® TA 100 (Essen-Degussa, Germany)), palmitamidopropyltrimonium chloride (e.g., VARISOFT® PATC (Essen-Degussa, Germany)), and cetearyl alcohol (and) palmitamidopropyltrimonium chloride (e.g., TEGO® Care CE 40).

In non-limiting embodiments of the invention, the amount of cationic emulsifier may be between about 0.2 and 1.0 percent and preferably between about 0.3 and 0.7 percent by weight of the cleansing composition.

### 4.3 Dispersing Auxiliary Solvents

Non-limiting examples of dispersing auxiliary solvents which may be used according to the invention include polyglycerols (e.g., diglycerol), polyglycerol esters, dipropylene glycol, tripropylene glycol, and tetrapropylene glycol.

In non-limiting embodiments of the invention, the amount of dispersing auxiliary solvent may be between about 0.5 and 8.0 percent or between about 0.5 and 5.0 percent, by weight, of the cleansing composition.

### 4.4 Non-Ionic Polymers

A “non-ionic polymer,” as that term is used herein, is a compound which, in a cleanser composition, acts as a foaming agent or foam-stabilizing agent.

Non-limiting examples of non-ionic polymers which may be used according to the invention include polyethylene oxide (e.g., Polyox polymers, such as Polyox N 60K), and pluronic block copolymer surfactants (e.g., Pluronic F87 Prill. F127, F108, L43, and 25R8).

In non-limiting embodiments of the invention, the amount of non-ionic polymer may be between about 1 and 8 percent by weight of the cleansing composition.

### 4.5 Solvent Systems

Solvent systems according to the invention comprise water and an alcohol.

Non-limiting examples of alcohols which may be used according to the invention include ethanol, SDA-40B alcohol, SDA-3 C alcohol and butanol.

In non-limiting embodiments, the amount of alcohol is between about and 30 percent by weight of the cleansing composition.

### 4.6 Alkanediols

In certain non-limiting embodiments, the present invention provides for compositions which comprise one or more alkanediol. Without being bound to any particular theory, it is believed that an alkanediol together with a cationic emulsifying agent forms a hydrophobic matrix on the skin upon application. Suitable alkanediols include, but are not limited to, dodecanediol, decanediol, nonanediol, octanediol, heptanediol, hexanediol and pentanediol. In particular non-limiting embodiments, the alkanediols have a carbon backbone of between 9 and 25 carbon atoms, including but not limited to 1,9 Nonanediol, 1,2-Decanediol, 1,10-Decanediol, 1,11-Undecanediol, 1,2-Dodecanediol, 1,12 Dodecanediol, Cyclododecanediol, 1,13-Tridecanediol, 1,2-Tetradecanediol, 1,14-Tetradecanediol, 1,15-Pentadecanediol, 1,16-Hexadecanediol, 1,17-Heptadecanediol, 1,18-Octadecanediol, 1,19-Nonadecanediol, 1,20-Eicosanediol, 1,21-Heneicosanediol, 1,22-Docosanediol, 1,23-Tricosanediol, 1,24-Tetracosanediol, 1,25-Pentacosanediol.

### 4.7 Cleanser Compositions

The present invention provides for cleanser compositions comprising one or more cationic antiseptic agents, a cationic emulsifying agent, a dispersing auxiliary solvent, a solvent system, and optionally an alkanediol with preferred embodiments further comprising one or more non-ionic polymer; said composition optionally further comprising: one or more thickening agent, one or more film-forming agent, one or more emollient, one or more cationic or non-ionic surfactants, one or more auxiliary foaming agent, an auxiliary antimicrobial agent, one or more fragrance, etc., including combinations thereof. The compositions of the invention, in certain embodiments, comprise anti-irritant amounts of zinc salts; in other embodiments, the compositions of the invention do not comprise anti-irritant amounts of zinc salts. In preferred non-limiting examples of the invention, a cleanser composition comprises three cationic antiseptic agents. In specific non-limiting embodiments of the invention, the cleanser comprises chlorhexidine, a quaternary ammonium compound, and triclosan, and, optionally, phenoxyethanol, and preferably contains no additional antimicrobial agent that contains an aromatic ring structure.

Non-limiting examples of film-forming agents include cellulosic film-fouling agents such as Ucare Polymer (e.g., Polyquaternary 10), hydroxypropylmethylcellulose (e.g., Methocel), and hydroxymethyl cellulose (e.g., Klucel), or a combination thereof. In specific non-limiting examples, the amount of cellulosic film-forming agent(s), where present, may be between about 0.05 and 0.5 percent by weight of the cleanser composition. Other examples of film-forming agents include silicone film-forming agents such as D.C. 200, 556, 1403 and D.C. silicone wax 580.

Non-limiting examples of an emollient which may be used according to the invention include silicone polymers (e.g., Dow Corning Q2-5220), glycerin, phospholipid complex, octanediol, pentanediol, hexanediol, Petrolatum, and mixtures thereof. In specific, non-limiting embodiments, the amount of emollient(s), where present, may be between about 1 and 5 percent by weight of the cleanser composition and, for petrolatum, between about 0.5 and 3 percent by weight of the composition.

Non-limiting examples of auxiliary foaming agents which may be used according to the invention include quaternised foaming coconut oil (e.g., Montaline® C-40, Seppic Inc., Fairfield, N.J.)), incromine oxide (e.g., Incromide oxide L), cocamidopropyl betaine or cocodimonium hydroxysultaine (e.g., Crosultaine C-50). In specific, non-limiting embodiments of the invention, the amount of surfactant/foaming agent(s), where present, may be between about 1 and 8 percent by weight of the cleanser composition.

A non-limiting example of an auxiliary antimicrobial agent is 2-phenoxy-ethanol. In specific, non-limiting embodiments of the invention, the amount of 2-phenoxy-ethanol may be between about 0.5 and 2 percent, or about 1 percent, by weight of the cleanser composition.

In particular non-limiting embodiments, the cleanser composition is a soap, which may be prepared as follows. Non-ionic polymer(s), water-soluble antiseptic agent(s), and cellulosic film-forming agent(s) (if any) may be mixed with water to form a first solution, which may be a gel (in a specific non-limiting embodiment, non-ionic polymer(s) and cellulosic film forming agent(s) may be mixed with water to form a gel to which water-soluble antiseptics are added). Auxiliary solvent and cationic emulsifying agent may then be mixed with alcohol and any alcohol-soluble antiseptic(s) or auxiliary antimicrobial agent may be added, to form a second solution. The first and second solutions may then be mixed, and surfactants/foaming agents and emollients may be added.

One or more alkanediol may be incorporated into any of the foregoing compositions. In further, particular non-limiting embodiments, the invention provides for a skin disinfectant composition comprising 1) one or more cationic antiseptic agent; 2) a film-forming cationic emulsifying agent; 3) a dispersing auxiliary solvent; 4) an alkanediol; and 5) a solvent system comprising an alcohol and water. Said compositions may further contain a thickening and/or film forming agent such as cationic cellulose polymer, film forming silicone, emollients, and/or cationic or non-ionic surfactants/foaming agents. Non-limiting specific examples of dispersing auxiliary solvents which may be comprised in such compositions include 0.5-5 percent polyglycerol (w/w) (diglycerol) or dipropylene glycol. A non-limiting example of a film-forming emulsifier which may be comprised in such compositions is 0.3-1.0% behenyltrimonium methosulfate in cetearyl alcohol (Incroquat Behenyl TMS). Specific non-limiting examples of alkanediols which may be comprised in such compositions include but are not limited to C5-C14-containing compounds. Specific non-limiting examples of alcohols which may be comprised in such compositions include 5-20% w/w ethanol, SDA-40B alcohol and SDA-3 alcohol. Specific non-limiting examples of antimicrobial agents which may be comprised in such compositions include 0.2-1.0% w/w biguanide (e.g. chlorhexidine and/or polyhexamethelene biguanide); 0.15-1% w/w triclosan; 0.1-0.3% w/w benzathonium chloride or benzalkonium chloride or a combination thereof. Specific non-limiting examples of film-forming cellulosic polymers which may be comprised in such compositions include 0.05-0.5% w/w UCare polymer (Polyquaternary 10); 0.05-0.5% w/w hydroxypropylmethyl cellulose (Methocel), or 0.05-0.5% w/w hydroxymethylcellulose (Klucel) or a combination thereof. Specific non-limiting examples of emollients which may be comprised in such compositions include a silicone polymer such as Dow Corning Q2-5220 (e.g. 0.5-3.0%), glycerin, and/or phospholipid complex. Non-limiting examples of surfactants/foaming agents which may be comprised in such compositions include 1-8% w/w quaternized foaming coconut oil (Montaline C40), 1-8% w/w incromine oxide, or 1-8% w/w cocoamidopropylbetaine. Non-limiting examples of film-forming silicones which may be comprised in such compositions include Dow Corning silicones 200, 556, 580 and/or 1403.

Specific non-limiting embodiments of compositions according to the invention are provided below and in the example sections, and those provided in the example sections are incorporated into this section by reference.

### Soaps Containing Octanediol

| | Percentage (w/w) | | |
|---|---|---|---|
| Ingredients | TCB-Z Soap | TCB-Z-O Soap | TCB-O Soap |
| Deionized Water | 59.22 | 58.72 | 59.12 |
| Zinc Lactate | 0.2 | 0.2 | — |
| Zinc gluconate | 0.2 | 0.2 | — |
| Pluronic F87 Prill | 2.0 | 2.0 | 2.0 |
| Polyox N-60K | 0.2 | 0.2 | 0.2 |
| U-care JR 30M | 0.4 | 0.4 | 0.4 |
| Montaline C-40 | 5.0 | 5.0 | 5.0 |
| Incromide Oxide L | 8.0 | 8.0 | 8.0 |
| Crosultaine C-50 | 3.0 | 3.0 | 3.0 |
| 2-Phenoxyethanol | 1.0 | 1.0 | 1.0 |
| Diglycerol | 2.0 | 2.0 | 2.0 |
| SDA 40B alcohol | 15.0 | 15.0 | 15.0 |
| Incroquat Behenyl TMS | 0.3 | 0.3 | 0.3 |
| 1,2 Octanediol | — | 0.5 | 0.5 |
| D-L Panthenol 50W | 1.0 | 1.0 | 1.0 |
| Phospholipid CDM | 1.0 | 1.0 | 1.0 |
| Chlorhexidine gluconate | 1.0 | 1.0 | 1.0 |
| (20% Solution) | | | |
| Benzethonium Chloride | 0.18 | 0.18 | 0.18 |
| Triclosan | 0.3 | 0.3 | 0.3 |

### Soaps Containing Pentanediol, and Symdiol

### Hexanediol+Octanediol

Percentage (w/w)

| Ingredient | TCB-Z-P Soap | TCB-Z-Sym Soap |
|---|---|---|
| Deionized Water | 58.72 | 58.72 |
| Zinc Lactate | 0.2 | — |
| Zinc gluconate | 0.2 | — |
| Pluronic F87 Prill | 2.0 | 2.0 |
| Polyox N-60K | 0.2 | 0.2 |
| U-care JR 30M | 0.4 | 0.4 |
| Montaline C-40 | 5.0 | 5.0 |
| Incromide Oxide L | 8.0 | 8.0 |
| Crosultaine C-50 | 3.0 | 3.0 |
| 2-Phenoxyethanol | 1.0 | 1.0 |
| Diglycerol | 2.0 | 2.0 |
| SDA 40B alcohol | 15.0 | 15.0 |
| Incroquat Behenyl TMS | 0.3 | 0.3 |
| 1,2 Pentanediol | 0.5 | — |
| Symdiol | — | 0.5 |
| D,L Panthenol 50W | 1.0 | 1.0 |
| Phospholipid CDM | 1.0 | 1.0 |
| Chlorhexidine gluconate | 1.0 | 1.0 |
| (20% solution) | | |
| Benzethonium Chloride | 0.18 | 0.18 |
| Triclosan | 0.3 | 0.3 |

### Soaps Containing Decanediol and Dodecanediol

Percentage (w/w)

| Ingredient | TCB-Z-D Soap | TCB-Z-Dod Soap |
|---|---|---|
| Deionized Water | 58.72 | 59.12 |
| Zinc Lactate | 0.2 | — |
| Zinc gluconate | 0.2 | — |
| Pluronic F87 Prill | 2.0 | 2.0 |
| Polyox N-60K | 0.2 | 0.2 |
| U-care JR 30M | 0.4 | 0.4 |
| Montaline C-40 | 5.0 | 5.0 |
| Incromide Oxide L | 8.0 | 8.0 |
| Crosultaine C-50 | 3.0 | 3.0 |
| 2-Phenoxyethanol | 1.0 | 1.0 |
| Diglycerol | 2.0 | 2.0 |
| SDA 40B alcohol | 15.0 | 15.0 |
| Incroquat Behenyl TMS | 0.3 | 0.3 |
| 1,2 Decanediol | 0.5 | — |
| 1,12 Dodecanediol | — | 0.5 |
| D,L Panthenol 50W | 1.0 | 1.0 |
| Phospholipid CDM | 1.0 | 1.0 |
| Chlorhexidine gluconate | 1.0 | 1.0 |
| (20% solution) | | |
| Benzethonium Chloride | 0.18 | 0.18 |
| Triclosan | 0.3 | 0.3 |

### Foaming Cleanser with C5-C8 Alkanediol

### General Formula

| Ingredient | Percentage |
|---|---|
| Water | 50-65 |
| Zinc Lactate | 0.05-0.8 |
| Zinc Gluconate | 0.05-0.5 |
| Pluronic F-87 | 1.0-5.0 |
| Diglycerin 801 | 0.5-2.0 |
| D,L Panthenol (50%) | 0.5-1.0 |
| Chlorhexidine/PHMB | 0.05-1.0 |
| Benzethonium Chloride | 0.1-0.3 |
| Lactic Acid (88%) | 0.2-1.0 |
| C5-C8 alkanediol | 0.5-1.0 |
| SDA 40B alcohol | 10-15 |
| Incroquat Behenyl TMS | 0.2-0.7 |
| Triclosan | 0.15-1.0 |
| PHMB | 0.1-0.3 |
| Phenoxy ethanol | 0.5-1.0 |
| Montaline C-40 | 3-5 |
| Incromine Oxide L | 3-8. |
| Silicone D.C. 556 | 0-1 |
| Solubilizer 611674 (Symrise) | 0-2.0 |
| Fragrance | 0-1.5 |
| FD&C Red 40 (.1%) | 0-1.0 |
| Total With water | 100.0 |

In non-limiting embodiments, the present invention provides for the following topical formulations.

### TCB-Z Cream

### Comprising Triclosan, Chlorhexidine, Benzathonium Chloride and Zinc Salts

| Ingredient | Percentage (w/w) |
|---|---|
| Water | 71.52 |
| Ucare JR 40 | 0.3 |
| Zinc gluconate | 0.2 |
| Zinc lactate | 0.2 |
| Zinc oxide | 0.2 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Triclosan | 0.3 |
| Chlorhexidine gluconate | 0.2 |
| Benzathonium Chloride | 0.18 |

### TPB-Z Cream

### Comprising Triclosan, PHMB, Benzathonium Chloride and Zinc Salts

| Ingredient | Percentage (w/w) |
|---|---|
| Water | 72.02 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Triclosan | 0.3 |
| PHMB | 0.3 |
| Benzathonium Chloride | 0.18 |

### TPB-Z-P Cream

### Comprising Triclosan, PHMB, Benzathonium Chloride Zinc Salts and Pentanediol

| Ingredient | Percentage (w/w) |
|---|---|
| Water | 71.02 |
| Zinc gluconate | 0.2 |
| Zinc lactate | 0.2 |
| Zinc oxide | 0.2 |
| D,L Panthenol | 0.5 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Triclosan | 0.3 |
| PHMB | 0.3 |
| Benzathonium Chloride | 0.18 |
| Pentanediol | 0.5 |

### FPBT-Z-Cream

### Comprising Farnesol, PHMB, Benzathonium Chloride, Triclosan, Zinc Salts

| Ingredient | Percentage (w/w) |
|---|---|
| Water | 70.92 |
| Zinc gluconate | 0.2 |
| Zinc lactate | 0.2 |
| Zinc oxide | 0.2 |
| D,L Panthenol | 0.5 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| PHMB | 0.3 |
| Benzathonium Chloride | 0.18 |
| Triclosan | 0.3 |

### FPBT-Z-P Cream

### Comprising Farnesol, PHMB, Benzathonium Chloride, Triclosan, Zinc Salts and Pentanediol

| Ingredient | Percentage (w/w) |
|---|---|
| Water | 71.42 |
| Zinc gluconate | 0.2 |
| Zinc lactate | 0.2 |
| Zinc oxide | 0.2 |
| D,L Panthenol | 0.5 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| PHMB | 0.3 |
| Benzathonium Chloride | 0.18 |
| Triclosan | 0.3 |
| Pentanediol | 0.5 |

### FPBT-Z-O Cream

### Comprising Farnesol, PHMB, Benzathonium Chloride, Triclosan, Zinc Salts and Octanediol

| Ingredient | Percentage (w/w) |
|---|---|
| Water | 70.92 |
| Zinc gluconate | 0.2 |
| Zinc lactate | 0.2 |
| Zinc oxide | 0.2 |
| D,L Panthenol | 0.5 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| PHMB | 0.3 |
| Benzathonium Chloride | 0.18 |
| Triclosan | 0.3 |
| Octanediol | 0.5 |

### SFP-Z-O Cream

### Comprising Sensiva, Farnesol, PHMB, Zinc Salts and Octanediol

| Ingredient | Percentage (w/w) |
|---|---|
| Water | 67.4 |
| Zinc gluconate | 0.2 |
| Zinc lactate | 0.2 |
| Zinc oxide | 0.2 |
| D,L Panthenol | 0.5 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| Octoxyglycerin (Sensiva) | 2.0 |
| PHMB | 0.3 |
| Phospholipid CDM | 1.0 |
| 1,2 Octanediol | 0.5 |

### SFPTr-Z-O Cream

### Comprising Sensiva, Farnesol, PHMB, Tea Tree Oil Zinc Salts and Octanediol

| Ingredient | Percentage (w/w) |
|---|---|
| Water | 66.9 |
| Zinc gluconate | 0.2 |
| Zinc lactate | 0.2 |
| Zinc oxide | 0.2 |
| D,L Panthenol | 0.5 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| Octoxyglycerin (Sensiva) | 2.0 |
| Tea tree oil | 0.5 |
| PHMB | 0.3 |
| Phospholipid CDM | 1.0 |
| 1,2 Octanediol | 0.5 |

### Antibacterial Anti-Inflammatory Cream (SFP-Z-O-AS)

### Comprising Sensiva, Farnesol, PHMB, Zinc Salts, Octanediol and the Anti-Inflammatory Agent Acetyl Salicylic Acid

| Ingredient | Percentage (w/w) |
|---|---|
| Water | 66.4 |
| Zinc gluconate | 0.2 |
| Zinc lactate | 0.2 |
| Zinc oxide | 0.2 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| Octoxyglycerin (Sensiva) | 2.0 |
| Tea tree oil | 0.5 |
| PHMB | 0.3 |
| Phospholipid CDM | 1.0 |
| 1,2 Octanediol | 0.5 |
| Acetyl salicylic acid | 0.5 |

### Antibacterial Anti-Inflammatory Cream (SFP-Z-D-AS)

### Comprising Sensiva, Farnesol, PHMB, Zinc Salts, Decanediol and the Anti-Inflammatory Agent Acetyl Salicylic Acid

| Ingredient | Percentage (w/w) |
|---|---|
| Water | 66.4 |
| Zinc gluconate | 0.2 |
| Zinc lactate | 0.2 |
| Zinc oxide | 0.2 |
| Ucare JR 40 | 0.3 |
| Polowax | 3.0 |
| Incroquat Behenyl TMS | 3.0 |
| Petroleum jelly | 5.0 |
| Stearyl alcohol | 7.0 |
| Propylene glycol | 2.0 |
| Isopropyl myristate | 4.0 |
| Sorbitan oleate | 2.0 |
| Polyoxyl 40 stearate | 2.0 |
| Farnesol | 0.5 |
| Octoxyglycerin (Sensiva) | 2.0 |
| Tea tree oil | 0.5 |
| PHMB | 0.3 |
| Phospholipid CDM | 1.0 |
| 1,2 decaenediol | 0.5 |
| Acetyl salicylic acid | 0.5 |

In specific non-limiting embodiments, the present invention provides for a hand disinfectant gel comprising an alkanediol, a cationic antiseptic agent, a film-forming cationic emulsifying agent, a dispersing auxiliary solvent and one or more essential oil for inactivating spores.

### Healthcare Handwash with Sporicidal Agents

### HH-1

| Constituent | % (w/w) |
|---|---|
| Panthenol 75W (BASF) | 0.375 |
| Zinc lactate | 0.20 |
| Benzethonium chloride | 0.18 |
| Symdiol 68T | 1.0 |
| Zinc gluconate | 0.20 |
| Farnesol | 0.50 |
| Cedar wood oil | 0.5 |
| Tea tree oil | 0.5 |
| Glucam P20 (Chemron) | 0.50 |
| Incroquat TMS Behenyl (Croda) | 0.30 |
| Methocell K4MS (Dow) | 0.50 |
| Polawax A31 (Croda) | 0.50 |
| Cosmocil CQ [PHMB (20% solution) | 1.5 |
| Phenoxyethanol | 0.70 |
| Alcohol (SDA-3C) | 57.0 |
| Sodium perborate | 2.0 |
| Water | 33.6 |
| Fragrance | 50 μl |

### HH-2

| Constituent | % (w/w) |
|---|---|
| Panthenol 75W (BASF) | 0.375 |
| Zinc lactate | 0.20 |
| Benzethonium chloride | 0.18 |
| Symdiol 68T | 1.0 |
| Zinc gluconate | 0.20 |
| Farnesol | 0.50 |
| Cedar wood oil | 0.5 |
| Tea tree oil | 0.5 |
| Glucam P20 (Chemron) | 0.50 |
| Incroquat TMS Behenyl (Croda) | 0.30 |
| Methocell K4MS (Dow) | 0.50 |
| Polawax A31 (Croda) | 0.50 |
| Cosmocil CQ [PHMB (20% solution) | 1.5 |
| Phenoxyethanol | 0.70 |
| Alcohol (SDA-3C) | 57.0 |
| Peracetic acid | 3.0 |
| Water | 32.6 |
| Fragrance | 50 μl |

### 4.8 Methods of Use

The cleanser compositions may be used to provide antimicrobial activity in methods comprising exposing a surface in need of such treatment to an effective amount of a cleanser composition as set forth above, for an effective period of time. An effective period of time may be at least about five seconds, at least about ten seconds, at least about twenty seconds, at least about thirty seconds, between thirty seconds and a minute, or between one minute and five minutes. In preferred non-limiting embodiments of the invention, antimicrobial activity is manifested as a log₁₀ reduction in bacteria of at least about 0.5, or at least about 1, or at least about 1.2, or at least about 1.5.

The cleanser compositions may be used to provide residual (persistent) antimicrobial activity in methods comprising exposing a surface in need of such treatment to an effective amount of a cleanser composition as set forth above, for an effective period of time. An effective period of time may be at least about five seconds, at least about ten seconds, at least about twenty seconds, at least about thirty seconds, between thirty seconds and a minute, or between one minute and five minutes. In preferred non-limiting embodiments of the invention, residual (persistent) antimicrobial activity is activity that persists for at least about 30 minutes.

The surface may be skin or mucous membrane of a human or non-human subject or may be a surface of an inanimate object, such as a telephone, a piece of medical examination equipment (e.g. a stethoscope or examination table), a piece of furniture, etc.

Accordingly, the cleansers of the invention may be used as topical skin cleansers, hand washes, personal washes, surgical scrubs, healthcare hand washes, household cleaners, and the like. Optionally, a cleanser of the invention may be incorporated into a cleaning wipe.

### 5. EXAMPLE

### Selection of Antiseptic Agents

Experiments were performed to evaluate the antimicrobial activity of combination of either

1) Chlorhexidine gluconate (CHG), Triclosan (TC) and Benzathonium chloride (BZT), or

2) Polyhexamethylene biguanide (PHMB), TC and BZT; relative to the antimicrobial activity of individual agents.

The various antiseptics and combinations of antiseptics were incorporated in a soap base (Base C) as given in Table 1. To 0.9 ml of the base, 0.1 ml of 108 cfu/ml of S. aureus was added and mixed for one minute, after which 9.0 ml of drug inactivating media was added. The samples were mixed well and serial dilutions were made with drug inactivating media. Various dilutions were plated on TSA plates. As the control, 9.0 ml of soap base was used. The results are shown in Table 1.

Soap base C

| Ingredient | Percentage (w/w) |
|---|---|
| Deionized Water | 82.4 |
| Polyox N 60K | 0.2 |
| Pluronic F 87 Prill | 2.0 |
| U-care | 0.4 |
| Montaline c-40 | 8.0 |
| Incromide Oxide L | 3.0 |
| Crosultaine C-50 | 3.0 |
| 2-Phenoxy-Ethanol | 1.0 |

TABLE 1

| | | Log10 reduction |
|---|---|---|
| Antiseptics in base | Colony counts | from Control |
| Control | 3.0 × 10⁷ | — |
| 0.5% TC | 4.3 × 10⁶ | 0.89 |
| 0.2% CHG | 4.1 × 10⁶ | 0.92 |
| 0.3% PHMB | 2.0 × 10⁶ | 1.17 |
| 0.18% BZT | 3.9 × 10⁶ | 0.94 |
| 0.5% TC + 0.2% CHG | 1.0 × 10⁶ | 1.53 |
| 0.5% TC + 0.2% CHG + 0.18% BZT | 4.0 × 10⁴ | 2.9 |
| 0.5% TC + 0.3% PHMB + 0.18% | 1 × 10⁴ | 3.47 |
| BZT | | |

### 6. EXAMPLE

### Soap Compositions

### Soap P1

| Ingredient | Percentage (w/w) |
|---|---|
| Deionized Water | 71.82 |
| Polyox N 60K | 0.2 |
| Pluronic F 87 Prill | 1.0. |
| Incromide Oxide L | 3.0 |
| Cocoamidopropylbetaine | 1.0 |
| 2-Phenoxy-Ethanol | 1.0 |
| Diglycerol | 5.0 |
| Chlorhexidine gluconate (20% solution) | 1.0 |
| Benzethonium Chloride | 0.18 |
| SDA 40B | 15.0 |
| Incroquat Behenyl TMS | 0.3 |
| Triclosan | 0.5 |

### Soap P-2

| Ingredient | Percentage (w/w) |
|---|---|
| Deionized Water | 70.52 |
| Zinc gluconate | 0.2 |
| Zinc lactate | 0.1 |
| Polyox N 60K | 0.2 |
| Pluronic F 87 Prill | 1.0. |
| D,L Panthenol 50W | 1.0 |
| Incromide Oxide L | 3.0 |
| Cocoamidopropylbetaine | 1.0 |
| 2-Phenoxy-Ethanol | 1.0 |
| Diglycerol | 5.0 |
| Chlorhexidine gluconate (20% solution) | 1.0 |

### Soap P 3

| Ingredient | Percentage (w/w) |
|---|---|
| Deionized Water | 58.92 |
| Polyox N 60K | 0.2 |
| Pluronic F 87 Prill | 2.0 |
| U-care | 0.4 |
| Montaline c-40 | 8.0 |
| Incromide Oxide L | 3.0 |
| Crosultaine C-50 | 3.0 |
| 2-Phenoxy-Ethanol | 1.0 |
| Diglycerol | 3.0 |
| Q2-5220 Resin Modifier | 0.5 |
| Chlorhexidine gluconate (20% solution) | 1.0 |
| Benzethonium Chloride | 0.18 |
| SDA 40B | 15.0 |
| Incroquat Behenyl TMS | 0.3 |
| Triclosan | 0.5 |
| 1,2 Octanediol | 1.0 |
| CDM Phospholipid | 2.0 |

### Soap P-4

| Ingredient | Percentage (w/w) |
|---|---|
| Deionized Water | 58.72 |
| Methocel 40-202 | 0.2 |
| Polyox N 60K | 0.2 |
| Pluronic F 87 Prill | 2.0 |
| U-care | 0.4 |
| Montaline c-40 | 8.0 |
| Incromide Oxide L | 3.0 |
| Crosultaine C-50 | 3.0 |
| 2-Phenoxy-Ethanol | 1.0 |
| Diglycerol | 3.0 |
| Q2-5220 Resin Modifier | 0.5 |
| Chlorhexidine gluconate (20% solution) | 1.0 |
| Benzethonium Chloride | 0.18 |
| SDA 40B | 15.0 |
| Incroquat Behenyl TMS | 0.3 |
| Triclosan | 0.5 |
| 1,2 Octanediol | 1.0 |
| CDM Phospholipid | 2.0 |

### Soap P 5

| Ingredient | Percentage (w/w) |
|---|---|
| Deionized Water | 54.92 |
| Zinc Lactate | 0.2 |
| Zinc gluconate | 0.3 |
| Polyox N 60K | 0.2 |
| Pluronic F 87 Prill | 2.0 |
| U-care | 0.4 |
| Montaline C-40 | 7.0 |
| Incromide Oxide L | 7.0 |
| 2-Phenoxy-Ethanol | 1.0 |
| Diglycerol | 5.0 |
| D.C Q2-5220 Silicone | 1.0 |
| D-L Panthenol 50W | 1.0 |
| Chlorhexidine gluconate (20% solution) | 1.0 |
| Benzethonium Chloride | 0.18 |
| SDA 40B | 15.0 |
| Incroquat Behenyl TMS | 0.3 |
| Triclosan | 0.5 |
| 1,2 Octanediol | 1.0 |
| CDM Phospholipid | 2.0 |

### Soap P6

| Ingredient | Percentage (w/w) |
|---|---|
| Deionized Water | 71.57 |
| Polyox N 60K | 0.1 |
| Ucare JR30 | 0.15 |
| Pluronic F 87 Prill | 1.0 |
| Incromide Oxide L | 1.0 |
| Cocoamidopropylbutane | 1.0 |
| Farnesol | 0.5 |
| Diglycerol | 5.0 |
| Chlorhexidine gluconate (20% solution) | 1.0 |
| Benzethonium Chloride | 0.18 |
| SDA 40B | 15.0 |
| Incroquat Behenyl TMS | 0.5 |
| Triclosan | 0.5 |
| Hydrolite 5(Pentanediol + hexanediol) | 2.5 |

### 7. EXAMPLE

### Method of Preparing a Soap

Polyox N 60 K and Pluronic F 87 surfactant and cellulose polymers such as Ucare JR 30 and Methocel are dissolved in water until a gel is formed (Gel A) and Chlorhexidine gluconate (CHG) and Benzathonium chloride (BZT) are mixed with GelA. The auxiliary solvent Diglycerol is then added. Incroquat Behenyl TMS is dissolved in alcohol (solution B) and triclosan and phenoxy ethanol are then mixed with solution B. solution B is added to Gel A and mixed thoroughly. To the A+B Gel mixture, surfactants/foaming agents and emollients are added.

### 8. EXAMPLE

### In Vitro Evaluation of Activity

The antimicrobial efficacy of Soap P1 according to the invention (see Section 6) was evaluated using a modification of the FDA procedure (FDA MONOGRAPH PART IV 21 CFR PARTS 333 AND 369).

A fresh overnight culture of bacteria was prepared and diluted to obtain 10⁹ cfu organism/ml. 0.1 ml of this diluted culture and 0.1 ml of Bovine Serum were introduced into a sterile culture tube. 0.8 ml of the soap formulation to be tested was added to the tube and then vortexed for 30 seconds. For the control, 0.9 ml of PBS (Phosphate buffered saline) was added to the tube containing the culture and processed the same way as the test soaps. Then, 9.0 ml of drug inactivating media was added to neutralize the activity of the soap, and the tube was vortexed. Serial dilutions were made using drug inactivating media. 0.5 ml from various dilutions were plated on Trypticase Soy agar plates. TSA plates). The plates were then incubated at 37° C. for 24-48 hours, and then the colony counts were measured. The results are shown in Table 2.

TABLE 2

| Organism | Log 10 Reduction from control counts* |
|---|---|
| S. epidermidis | 4.458 |
| S. aureus | 2.1 |
| MRSA | 2.1 |
| E. faecalis | 4.18 |
| VREF | 4.83 |
| Pseudomonas | 8.53 |
| Serratia | 3.81 |
| Acinetobacter | 8.36 |
| E. coli | 8.52 |
| Klebsiella | 8.57 |
| Enterobacter | 3.81 |

*Control counts are 1-2 × 10⁸ cfu/ml

### 9. EXAMPLE

### In Vivo Testing 1

This test was carried out to determine the residual antimicrobial remaining in the hand 5 minutes after washing the soap from the hand.

Trypticase agar plates were seeded with 3×10³ cfu S. aureus.

Hands were washed with Soap P2 (see section 6), after donning a glove on the left hand (which served as the control). After washing, the glove was removed off the left hand. After allowing the hands to air dry for 5 minutes, the 3 middle fingers from both hands were pressed on the inoculated agar plate. One minute later, the same middle fingers of both hands were pressed onto two separate fresh (uninoculated) plates. After incubation at 37° C. for 24 hours, the bacterial colonies in the plates were counted. The results are shown in Table 3.

TABLE 3

| | Control hand | Test hand |
|---|---|---|
| | CFU/Plate | CFU/Plate |
| Volunteer 1 | 80 | 0 |
| Volunteer 2 | 137 | 0 |

The results indicate that the hand washed with soap P2 showed retention of activity 5 minutes after washing.

### 10. EXAMPLE

### In Vivo Testing 2

To test residual activity 30 minutes after washing with soap P3, hands were washed with water, dried, and a glove was donned on the left hand. 5 ml soap P3 was dispensed on the palm of the hand and was spread for 15 seconds, then a small amount of water was added to the palm and lathered for another 15 seconds. The hands were washed for 15 seconds and then rinsed and dried with paper towel. The glove was removed from the left hand. After 30 minutes the middle 3 fingers from both hands were pressed for 5 seconds on a TSA plate seeded with 0.3 ml of 10⁵ cfu S. aureus/ml. After 1 minute, the fingers were pressed on a sterile agar plate to see the transfer of bacteria from the hand to the plate. The gloved hand was used as the control. After incubation at 37° C. for 24 hours the bacterial colonies on the plates were counted.

The results are shown in Table 4, below.

TABLE 4

| | | Log 10 reduction |
|---|---|---|
| Result | Log 10 Counts | from the control |
| Control | 1.9 | — |
| Soap P 3 | 0 | 1.9 |

The foregoing data indicate that the hand washed with soap P 3 showed residual activity 30 minutes post washing.

### 11. EXAMPLE

### Comparison with Commercial Product

To compare the efficacy of soap P5 (see Section 6) with commercially available Dial Complete® (which contains 0.46 percent triclosan), essentially the same method set forth in section 10 was used, except that after pressing the hands on plates seeded with bacteria, they were pressed on drug inactivating agar. The test plates were incubated at 37° C. for 24 hours. The results are presented in Table 5.

TABLE 5

| | | Log 10 reduction |
|---|---|---|
| | Log 10 Counts | from the control |
| Control | 1.0 | — |
| Dial Complete ® | 1.19 | −0.19 |
| (0.46% Triclosan) | | |
| Soap P5 | 0.3 | 0.7 |

The results shown in Table 5 indicate that 30 minutes after washing, the hand washed with Soap P5 a exhibited superior antimicrobial activity relative to Dial Complete.

### 12. EXAMPLE

### Efficacy Testing on Pig Skin

In these experiments, the residual antimicrobial activity of Soap P6 (see Section 6) was compared to Soap 30, having the following formulation.

Composition of Soap 30

| Ingredient | Percentage (w/w) |
|---|---|
| Deionized Water | 71.82 |
| Zinc gluconate | 0.1 |
| Pluronic F 87 Prill | 1.0 |
| Polyox N-60K | 0.2 |
| U-care | 0.4 |
| Germal+ | 0.15 |
| Montaline C-40 | 3.0 |
| Incromide Oxide L | 3.0 |
| 2-Phenoxy-Ethanol | 1.0 |
| Glycerin | 2.0 |
| SDA40 B alcohol | 14 |
| D-L Panthenol 50W | 1.0 |
| Chlorhexidine gluconate | 0.2 |
| Benzethonium Chloride | 0.18 |
| PHMB | 0.30 |
| Farnesol | 0.3 |
| Triclosan | 0 |

Two sets of pigskins were used for each group.

Control skins were washed with non-antimicrobial soap and the test skins were washed with either soap P6 or soap 30, with 20 seconds of lathering followed by 20 seconds of rinsing. After washing, the pig skins were dried and left at room temperature for 30 minutes.

Then, each skin was inoculated with 10 ul of 10⁵ cfu/ml S. aureus, which was spread on the skin for 30 seconds and then allowed to remain for another 30 seconds, after which 0.2 ml of drug inactivating media was applied and rubbed onto the skin for 15 seconds. The skins were then washed with 9.9 ml of drug inactivating media, and the washings were collected. Serial dilutions of the washings were made and plated on TSA plates. After incubating 24 hours at 37° C. the colony counts were determined. The results are shown in Table 6.

TABLE 6

| | | Log 10 reduction |
|---|---|---|
| | Log 10 Counts | from the control |
| Control* | 2.36 | — |
| Control** | 3.29 | 0.07 |
| Soap 30 | 3.2 | 0.16 |
| Soap P6 | 2.17 | 1.19 |

*no soap used
**regular (non-antimicrobial) soap used

The results indicate that Soap P6 had greater residual activity after 30 minutes than non-antibacterial soap or soap 30.

### 13. EXAMPLE

### Comparison Testing

The following study compared the persistence of antimicrobial activity of soaps having the same concentrations of cationic antiseptics, but where soap C10 lacked the auxiliary solvent diglycerol and the cationic emulsifier Incroquat TMS.

| | |
|---|---|
| | Percentage |
| Ingredient | (w/w) |

| Soap | PC2-5A | C10 |
|---|---|---|
| Deionized Water | 62.97 | 66.3 |
| Zinc Lactate | 0.1 | 0.1 |
| Zinc gluconate | 0.1 | 0.1 |
| Pluronic F 87 Prill | 1.0 | 1.0 |
| U-care | 0.2 | 0.2 |
| Montaline C-40 | 5.0 | 5.0 |
| Incromide Oxide L | 7.0 | 7.0 |
| 2-Phenoxy-Ethanol | 1.0 | 1.0 |
| Diglycerol | 5.0 | — |
| SDA40 B alcohol | 15 | 15 |
| Incroquat TMS | 0.3 | — |
| D-L Panthenol 50W | 1.0 | 1.0 |
| Chlorhexidine gluconate (20% solution) | 1.0 | 1.0 |
| Benzethonium Chloride | 0.23 | 0.23 |
| PHMB | 0.30 | 0.3 |
| Triclosan | 0.5 | 0.5 |

Two pigskins were used as controls, two pigskins were used to test PC2-5A soap and two pigskins were used to test C10 soap. After washing a pigskin with soap, it was air dried and left at room temperature for 2 hours. Then, each skin was pressed on an inoculated agar plate for 5 seconds, left at room temperature for 1 minute, and then pressed on a drug inactivating agar plate. The plates were incubated at 37° C. for 24 hours and colony counts were determined. Log reductions for the counts were calculated. and are shown in Table 7.

TABLE 7

| | | Log Reduction |
|---|---|---|
| | Log10 Counts | from the control counts |
| Control | 1.90 | — |
| Soap C10 | 1.0 | 0.9 |
| Soap PC25A | 0.12 | 1.78 |

The results indicate that the soap having auxiliary dispersing solvent and cationic emulsifier displayed greater persistent antimicrobial activity.

### 14. EXAMPLE

### Alkanediol Containing Soaps

Cleansing compositions were prepared containing alkanediols with carbon C5-C12, cationic antiseptic agents, a film-forming cationic emulsifying agent, a dispersing auxiliary solvent. In particular, soaps containing the following alkanediols were prepared: Pentanediol, Hexanediol+Octanediol (Symdiol), Octanediol, Decanediol, Dodecanediol were used in the following cleansing formulations.

### Soaps Containing Octanediol

| | Percentage (w/w) | | |
|---|---|---|---|
| Ingredients | TCB-Z Soap | TCB-Z-O Soap | TCB-O Soap |
| Deionized Water | 59.22 | 58.72 | 59.12 |
| Zinc Lactate | 0.2 | 0.2 | — |
| Zinc gluconate | 0.2 | 0.2 | — |
| Pluronic F87 Prill | 2.0 | 2.0 | 2.0 |
| Polyox N-60K | 0.2 | 0.2 | 0.2 |
| U-care JR 30M | 0.4 | 0.4 | 0.4 |
| Montaline C-40 | 5.0 | 5.0 | 5.0 |
| Incromide Oxide L | 8.0 | 8.0 | 8.0 |
| Crosultaine C-50 | 3.0 | 3.0 | 3.0 |
| 2-Phenoxyethanol | 1.0 | 1.0 | 1.0 |
| Diglycerol | 2.0 | 2.0 | 2.0 |
| SDA 40B alcohol | 15.0 | 15.0 | 15.0 |
| Incroquat Behenyl TMS | 0.3 | 0.3 | 0.3 |
| 1,2 Octanediol | — | 0.5 | 0.5 |
| D-L Panthenol 50W | 1.0 | 1.0 | 1.0 |
| Phospholipid CDM | 1.0 | 1.0 | 1.0 |
| Chlorhexidine gluconate | 1.0 | 1.0 | 1.0 |
| (20% Solution) | | | |
| Benzethonium Chloride | 0.18 | 0.18 | 0.18 |
| Triclosan | 0.3 | 0.3 | 0.3 |

### Soaps Containing Pentanediol, and Symdiol

### Hexanediol+Octanediol

Percentage (w/w)

| Ingredient | TCB-Z-P Soap | TCB-Z-Sym Soap |
|---|---|---|
| Deionized Water | 58.72 | 58.72 |
| Zinc Lactate | 0.2 | — |
| Zinc gluconate | 0.2 | — |
| Pluronic F87 Prill | 2.0 | 2.0 |
| Polyox N-60K | 0.2 | 0.2 |
| U-care JR 30M | 0.4 | 0.4 |
| Montaline C-40 | 5.0 | 5.0 |
| Incromide Oxide L | 8.0 | 8.0 |
| Crosultaine C-50 | 3.0 | 3.0 |
| 2-Phenoxyethanol | 1.0 | 1.0 |
| Diglycerol | 2.0 | 2.0 |
| SDA 40B alcohol | 15.0 | 15.0 |
| Incroquat Behenyl TMS | 0.3 | 0.3 |
| 1,2 Pentanediol | 0.5 | — |
| Symdiol | — | 0.5 |
| D,L Panthenol 50W | 1.0 | 1.0 |
| Phospholipid CDM | 1.0 | 1.0 |
| Chlorhexidine gluconate | 1.0 | 1.0 |
| (20% solution) | | |
| Benzethonium Chloride | 0.18 | 0.18 |
| Triclosan | 0.3 | 0.3 |

### Soaps Containing Decanediol and Dodecanediol

Percentage (w/w)

| Ingredient | TCB-Z-D Soap | TCB-Z-Dod Soap |
|---|---|---|
| Deionized Water | 58.72 | 59.12 |
| Zinc Lactate | 0.2 | — |
| Zinc gluconate | 0.2 | — |
| Pluronic F87 Prill | 2.0 | 2.0 |
| Polyox N-60K | 0.2 | 0.2 |
| U-care JR 30M | 0.4 | 0.4 |
| Montaline C-40 | 5.0 | 5.0 |
| Incromide Oxide L | 8.0 | 8.0 |
| Crosultaine C-50 | 3.0 | 3.0 |
| 2-Phenoxyethanol | 1.0 | 1.0 |
| Diglycerol | 2.0 | 2.0 |
| SDA 40B alcohol | 15.0 | 15.0 |
| Incroquat Behenyl TMS | 0.3 | 0.3 |
| 1,2 Decanediol | 0.5 | — |
| 1,12 Dodecanediol | — | 0.5 |
| D,L Panthenol 50W | 1.0 | 1.0 |
| Phospholipid CDM | 1.0 | 1.0 |
| Chlorhexidine gluconate | 1.0 | 1.0 |
| (20% solution) | | |
| Benzethonium Chloride | 0.18 | 0.18 |
| Triclosan | 0.3 | 0.3 |

### Foaming Cleanser with C5-C8 Alkanediol

### General Formula

| Ingredient | Percentage |
|---|---|
| Water | 50-65 |
| Zinc Lactate | 0.05-0.8 |
| Zinc Gluconate | 0.05-0.5 |
| Pluronic F-87 | 1.0-5.0 |
| Diglycerin 801 | 0.5-2.0 |
| D,L Panthenol (50%) | 0.5-1.0 |
| Chlorhexidine/PHMB | 0.05-1.0 |
| Benzethonium Chloride | 0.1-0.3 |
| Lactic Acid (88%) | 0.2-1.0 |
| C5-C8 alkanediol | 0.5-1.0 |
| SDA 40B alcohol | 10-15 |
| Incroquat Behenyl TMS | 0.2-0.7 |
| Triclosan | 0.15-1.0 |
| PHMB | 0.1-0.3 |
| Phenoxy ethanol | 0.5-1.0 |
| Montaline C-40 | 3-5 |
| Incromine Oxide L | 3-8. |
| Silicone D.C. 556 | 0-1 |
| Solubilizer 611674 (Symrise) | 0-2.0 |
| Fragrance | 0-1.5 |
| FD&C Red 40 (.1%) | 0-1.0 |
| Total With water | 100.0 |

Some of the foregoing soaps were then tested for antimicrobial activity. Four sets of pigskins were used for each group. Control skins were washed with non-antimicrobial soap (Plain soft soap) and the test skins were washed with test soaps (20 seconds lathering and 20 seconds rinsing). After washing, the pig skins were dried and left at room temperature for 60 minutes. The skins were pressed for 5 seconds on a pre inoculated Trypticase soy agar plate, inoculated with 0.5 ml of 10⁴ cfu/ml of S. aureus. After 1 minute, each skin was rinsed with 10 ml drug inactivating media and the washings were collected. Serial dilutions of the washings were made and plated on TSA plates. After incubating 24 hours at 37° C. the colony counts were determined. The results are shown in Table 8.

TABLE 8

| Soap Groups | Log10 reduction from the control |
|---|---|
| TCB-Z | 0.64 |
| TCB-Z-O | 1.0 |
| TCB-O | 1.02 |
| TCB-Z-P | 1.30 |
| TCB-Z-Sym | 1.29 |
| TCB-Z-D | 1.56 |
| TCB-Z Dod | 1.38 |

Bacterial growth in the Pig skin washed with Control soap ranged from 2×10² to 8×10²

### 15. EXAMPLE

### Effect of Film-Forming Silicones

Soaps were prepared containing cationic antiseptic agents, a film-forming cationic emulsifying agent, a dispersing auxiliary solvent, an alkanediol and a film forming silicone. Dow Corning cosmetic grade 556 silicone fluid was used; 0.5% of the silicone fluid was used in TCB, TCB-Z-P and TCB-Z-O and the efficacy was evaluated using the pigskin method described in Section 14. The results are shown in Table 9.

TABLE 9

| Soap Groups | Log 10 reduction from the control |
|---|---|
| TCB-Z-O | 1.0 |
| TCB-Z-O-S | 1.5 |
| TCB-Z-P | 1.29 |
| TCB-Z-P-S | 1.53 |

Bacterial growth in the Pig skin washed with Control soap ranges from 2×10² to 8×10²

These results indicate that the film forming silicon further enhances persistent antimicrobial activity.

### 16. EXAMPLE

### Topical Creams

It has been shown that healthcare workers play a major role in MRSA transmission, they become colonized or infected with MRSA from patients, but also can infect them and even become the MRSA carriers. Various topical creams (see Section 4.7 for formulations) were evaluated for their activity against MRSA infection using a pig skin model.

Six sets of 3×3 cm² Pig skin each mounted on a petri plate were rinsed in 70% Ethanol, and air dried; one piece of the pair was contaminated with 30 μl of 10⁸ cfu of MRSA culture; the two pieces were rubbed against each other for 30 seconds, and left at 37° C. dry for 1 hour. Three pairs were used for control and the other 3 pairs were used for the test creams. To one piece of the pair from the control, 0.1 gm of placebo cream (without the antibacterials) was applied, and rubbed against the other piece for 15 seconds and left at 37° C. for 2 hours. The same procedure was repeated with the skins in which the test cream was applied. Following this, 0.2 ml drug inactivating media (DM) was added to one skin piece and both pieces rubbed again for 15 seconds. The surviving organisms were recovered from the skin by rinsing each piece with 9.9 ml of DM. The washing fluid from both pieces was collected in one Petri dish, mixed and transferred to a culture tube from which further serial dilutions were made. Aliquots from the dilutions were plated on TSA plates and incubated for 24-48 hours at 37° C. before colony counts (baseline counts) were determined.

### Reduction of Bacterial Growth 2 Hour Post Treatment

TABLE 10

| | Log₁₀ reduction from |
|---|---|
| Treatment cream | control counts |
| Placebo cream (control) | — |
| FPBT-Z | 3.14 |
| FPBT-Z-O | 4.94 |
| SFP-Tr-Z-AS | 3.2 |
| SFP-Tr-Z-O-AS | 4.56 |

Bacterial growth in the Pig skin washed with Control soap ranges from 5×10⁶ to 1×10⁷

These results indicate that Alkanediols enhance the activity of creams containing antibacterials.

Various publications are cited herein, the contents of which are hereby incorporated by reference in their entireties.

We claim:

1. A cleanser composition comprising one or more cationic antiseptic agent, a cationic emulsifying agent, a dispersing auxiliary solvent, and a solvent system, which demonstrates residual antimicrobial activity.

2. The cleanser composition of claim 1, further comprising an alkanediol.

3. The cleanser composition of claim 1 or 2, further comprising one or more non-ionic polymer.

4. The cleanser of claim 1 or 2, comprising the cationic antiseptic agent chlorhexidine.

5. The cleanser of claim 4, further comprising the cationic antiseptic agent triclosan.

6. The cleanser of claim 4, further comprising the cationic antiseptic agent, a quaternary ammonium compound.

7. The cleanser of claim 5, further comprising the cationic antiseptic agent, a quaternary ammonium compound.

8. The cleanser of any of claims 1-7, wherein the cationic emulsifying agent is an incroquat compound.

9. The cleanser of any of claims 1-7, wherein the dispersing auxiliary solvent is selected from the group consisting of polyglycerols, polyglycerol esters, dipropylene glycol, tripropylene glycol, and tetrapropylene glycol.

10. The cleanser of claim 9, wherein the polyglycerol is diglycerol.

11. A method of providing antimicrobial activity to a surface, comprising exposing a surface in need of such treatment to an effective amount of a cleanser composition as set forth in any of claims 1-10, for an effective period of time.
